(19) United States
(12) Patent Application Publication
(10) Pub. No.: US 2018/0316641 A1
(43) Pub. Date: Nov. 1, 2018

(54) PUBLISH/SUBSCRIBE SYSTEM INCORPORATING DERIVATION ACTIONS

(71) Applicant: CA, Inc., New York, NY (US)

(72) Inventor: Serguei Mankovskii, Morgan Hill, CA (US)

(21) Appl. No.: 15/582,476

(22) Filed: Apr. 28, 2017

(51) Int. Cl. H04L 12/58; H04L 29/08

(52) U.S. Cl. CPC H04L 51/14; H04L 67/2842; H04L 51/12

(57) ABSTRACT

A pub/sub system lends itself to facilitating the publication of information from Internet of Things (IoT) devices to a variety of subscriber nodes. Subscriber nodes may access an application/web service to derive other information from the published information. Migrating the obtaining of derived information from the subscribers to the pub/sub intermediary can dramatically reduce load on web services. In addition, derived information can be cached at the pub/sub intermediary. This further reduces the web service load by reducing the number of requesters and lever aging previously derived information from web services.

### BACKGROUND

The disclosure generally relates to the field of data processing, and more particularly to multi computer data transferring.

A publisher/subscriber (pub/sub) system is a system that implements a pub/sub messaging pattern (also referred to as pub/sub communication model). With a pub/sub messaging pattern, a publisher publishes information (e.g., a message or event) to subscribers via an intermediary, sometimes referred to as a broker. Thus, publishers and subscribers are decoupled from each other. In a topic-based pub/sub system, a publisher identifies information by topic and publishes the information to a broker. The information from a publisher includes a topic designation and the payload information (or payload data). A subscriber subscribes to one or more topics with the broker. The broker filters and forwards information to subscribers according to their subscriptions. Other types of pub/sub communication models include content-based filtering and type-based filtering of information.

A pub/sub system establishes connections between publishers/subscribers and a broker(s), and communicates messages according to a protocol, such as the Message Queuing Telemetry Transport (MQTT) protocol. The Organization for the Advancement of Structured Information Standards (OASIS) describes the MQTT protocol as a lightweight client-server publish/subscribe messaging transport protocol. The protocol was originally created to collect data from multiple devices while using limited bandwidth to provide the data to multiple subscribers. These characteristics of the MQTT protocol lead to its use in Internet of Things (IoT) contexts where a small code footprint is desirable and/or network bandwidth is at a premium.

### BRIEF DESCRIPTION OF THE DRAWINGS

Embodiments of the disclosure may be better understood by referencing the accompanying drawings.

FIG. 1 is a conceptual diagram of a publisher/subscriber system that derives information from published information and caches the derived information for communicating to subscribers.

FIG. 2 is a flowchart of example operations for registering a publisher's intent to publish information.

FIG. 3 is a flowchart of example operations for associating an action invocation with one or more channels.

FIG. 4 is a flowchart of example operations for registering a subscription with a pub/sub system that incorporates derivation actions.

FIG. 5 is a flowchart of example operations for publishing derived information.

FIG. 6 depicts an example computer system with a derivation action map based publisher/subscriber broker.

### DESCRIPTION

The description that follows includes example systems, methods, techniques, and program flows that embody embodiments of the disclosure. However, it is understood that this disclosure may be practiced without these specific details. For instance, this disclosure depicts an example illustration with a broker that includes a channel catalog and an action library. Embodiments can implement a pub/sub broker that communicates with an externally managed channel catalog and/or action library. In other instances, well-known instruction instances, protocols, structures and techniques have not been shown in detail in order not to obfuscate the description.

Overview

A pub/sub system lends itself to facilitating the publication of information from Internet of Things (IoT) devices to a variety of subscriber nodes. Subscriber nodes may access an application/web service to derive other information from the published information. For instance, a subscriber node may obtain geographical coordinates from a subscribed channel and use a web service to derive one or more landmarks (e.g., names of businesses, parks, etc.) Proximate to the geographical coordinates. If thousands of geographic coordinates are published to thousands of subscribers, the web service may serve a million requests for derived landmarks. This load on web services can be dramatically reduced by migrating the obtaining of derived information from the subscribers to the pub/sub intermediary. In addition, derived information can be cached at the pub/sub intermediary. This further reduces the web service load by reducing the number of requesters and lever aging previously derived information from web services.

Example Illustrations

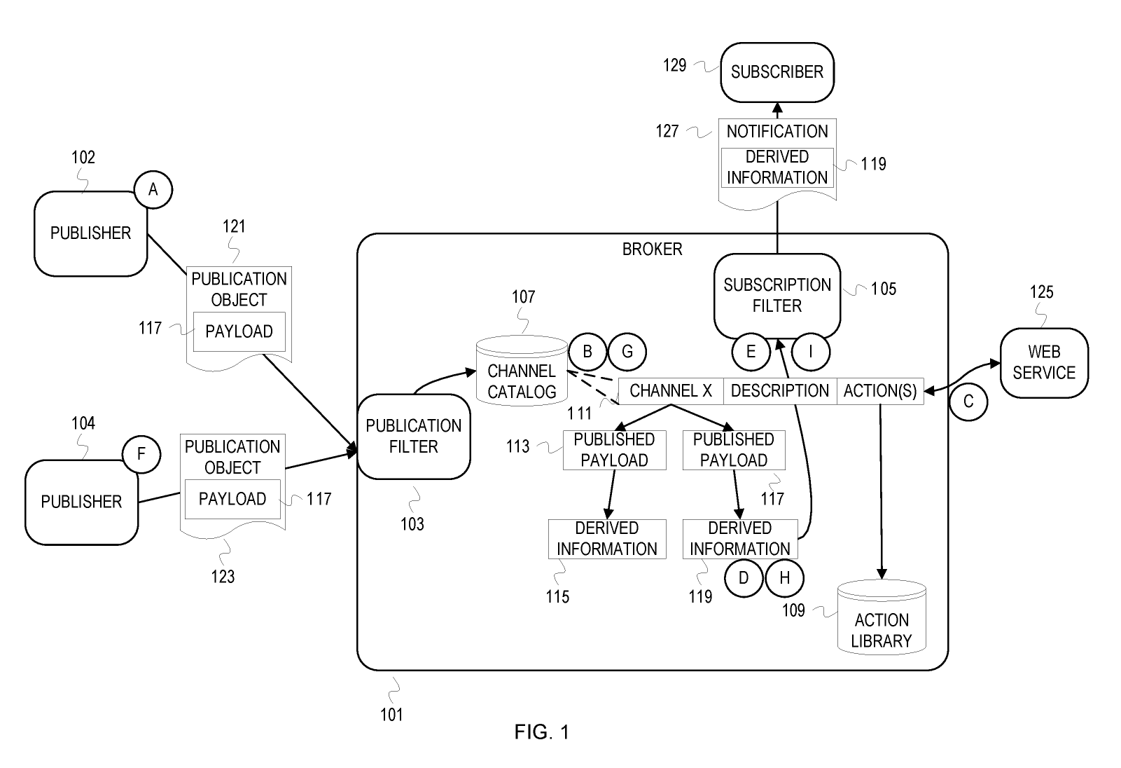

FIG. 1 is a conceptual diagram of a publisher/subscriber system that derives information from published information and caches the derived information for communicating to subscribers. The depicted pub/sub system comprises a broker 101, a publisher 102, a publisher 104, and a subscriber 129. For this illustration, the publishers 102, 104 have already registered with the broker 101 and the subscriber 129 has already subscribed to a channel X The channel X is a named logical channel for conveying published information that relates to a topic X or for published content related to X In this case, X relates to information derived from information published by the publishers 102, 104. The broker 101 comprises various components to manage published information and service subscriptions to published information. In this illustration, the broker 101 includes a publication filter 103, a subscription filter 105, a channel catalog 107, and an action library 109. The publication filter 103 matches published payloads to the appropriate channel(s) of the channel catalog 107 and updates the channel entry with the matching published payload(s). The subscription filter 105 matches information, whether published payloads or derived information, to subscribers based on previous subscriptions to channels in the channel catalog 107. The channel catalog 107 is a repository of channels. The channel catalog 107 can be implemented according to various techniques (e.g., as a database, an in-memory data structure, etc.).

FIG. 1 is annotated with a series of letters a A-I. These stages each represent one or more operations. Although these stages are ordered for this example, the stages illustrate one example to aid in understanding this disclosure and should not be used to limit the claims. Subject matter falling within the scope of the claims can vary with respect to the order and some of the operations.

At stage A, the publisher 102 publishes information to the broker 101. To publish information, the publisher 102 communicates a publication object 121 (e.g., a message or event) to the broker 101. The publication object 121 includes a payload 117. The publication object 121 may include a header and/or trailer for the payload 117. The payload 117 can include one or more publication items. Each publication item is a unit of data that can comprise a single value or array of values.

At stage B, the publication filter 103 matches the payload 117 to a channel entry 111 within the channel catalog 107. The channel entry 111 identifies a channel X. The publication filter 103 may match the payload 117 to the channel entry 111 based on the publication object 121 including a channel identifier for channel X previously communicated to the publisher 102, or the publication filter 103 matches the payload 117 to the channel entry 111 based on descriptors of the payload 117 in the publication object 121 and a description of channel X in the channel entry 111. For instance, the publication object 121 may identify the publisher 102 and include descriptors for the payload 117. The publication filter 103 searches the channel descriptions in the channel catalog 107 for one or more channels that match beyond a confidence threshold based on the publisher identifier and the payload descriptors. If no confident match is found, the channel catalog can create a channel.

At stage C, the publication filter 103 executes a derivation action invocation that maps to the channel X after determining that derived information does not already exist for the payload 117. The publication filter 103 traverses a structure of derived information associated with the channel entry 111 to determine whether the payload 117 has previously been published by the publisher 102, or perhaps another publisher depending upon arrangement of the channel catalog. At this point in the illustration, the published payload 117 has not yet been published to the channel X. The publication filter 103 determines a derivation action invocation that maps to the channel entry 111. A derivation action invocation is an invocation to a function, method, procedure, etc., that derives information from a published payload (e.g., a simple object access protocol request, a request that complies with Universal Description Discovery and Integration (UDDI), a remote procedure call encoded in the extensible markup language (XML-RPC) or the JavaScript Object Notation format (JSON-RPC), a request according to a Representational State Transfer (REST) protocol, etc.). The publication filter 103 populates the derivation action invocation with the payload 117 and executes the populated invocation. This communicates the payload 117 to a web service 125 identified in the derivation action invocation. The web service 125 processes the payload 117 according to the derivation action invocation and returns a result (i.e., returns derived information 119) to the broker 101. For instance, the web service 125 may be a web service that determines a geographic location based on an image. The web service 125 processes the image (i.e., the payload 117) and returns a geographic location (e.g., street address) determined from processing the image.

At stage D, the publication filter 103 updates the derivation information structure with the published payload 117 and with the derived information 119 in association with the payload 117. In this example illustration, the publication filter 103 updates the tree structure with the derived information 119 as a leaf node referenced by the published payload 117 which is depicted as an interior node of the derivation information structure of the channel entry 111.

At stage E, the subscription filter 105 communicates a notification 127 of the derived information 119 to a subscriber 129. The subscriber 129 previously subscribed to the channel X. The subscriber 129 subscribed to the channel X by communicating information to the broker 101 that indicated an interest in the derived information and the channel X. For instance, the subscriber 129 may be an instance of an application that displays landmarks near food trucks. Thus, the subscribe 129 communicates an interest in food truck locations to the broker 101. Each of the food trucks publish geographic coordinates to the broker 101. The broker 101 then communicates with the web service 125 to obtain landmarks near each of the food trucks. The broker 101 then provides the landmarks near food trucks to the subscriber 129. As another example, the subscriber 129 may be an instance of an application used to determine or approximate geographic locations based on images. The subscriber 129 communicates an interest in images and locations derived from images published from a class of publishers (e.g., non-governmental organization (NGO) drones and smartphones). The NGO drones and field agents publish images to the broker 101 and the broker 101 invokes the web service 125 to process the images and derive locations corresponding to the images. The broker 101 then communicates the locations and the images to the subscriber 129.

At stage F, the publisher 104 publishes the same publication payload 117 (e.g., same geographic coordinates or image) in a publication object 123 to the broker 101. For instance, vehicles may periodically report geographic coordinates to a pub/sub system and those coordinates may be the same sometimes.

At stage G, the publication filter 103 matches the payload 117 to the channel entry 111 for channel X. At this point in time, the publisher 102 has already published the payload 117 to the broker 101 and the derived information 119 from the web service 125 has already been cached by the broker 101. The publication filter 103 traverses the derivation information structure and determines that the payload 117 does not match a published payload 113, which is associated with derived information 115. The payload 113 may be a previously published set of geographic coordinates from either of the publishers 102, 104. The publication filter 103 then determines that the payload 117 from the publication object 123 is already in the derived information structure and already associated with the derived information 119 at stage H.

At stage I, the subscription filter 105 communicate the payload 117 to subscribers depending upon subscriber configuration. The subscription filter 105 can communicate the payload 117 to the subscriber 129 again, disregard the publication since it is the same if tracked, and/or notify another subscriber of the publication of the payload 117 and/or the derived information. As illustrated, the broker 101 can use derived information that has been cached to efficiently satisfy subscription communications without repeating the web service invocation, thus reducing network traffic and processing load on the web service 125. When considered in an actual deployment scenario of thousands of publisher nodes and thousands of subscriber nodes (e.g., thousands of IoT devices and thousands of applications), the reduction on a network and web services becomes substantial and appreciable.

Although FIG. 1 depicts a single instance of a broker, a pub/sub system can have a broker instantiated across multiple servers. For instance, a pub/sub service may have geographically distributed servers with broker instances. Each server may host multiple broker instances. Clusters of servers may share access to either one or both of the channel catalog and the action library. Regardless of the specific architectural implementation, a broker instance in accordance with this disclosure creates mappings between channels and action invocations to obtain derived information.

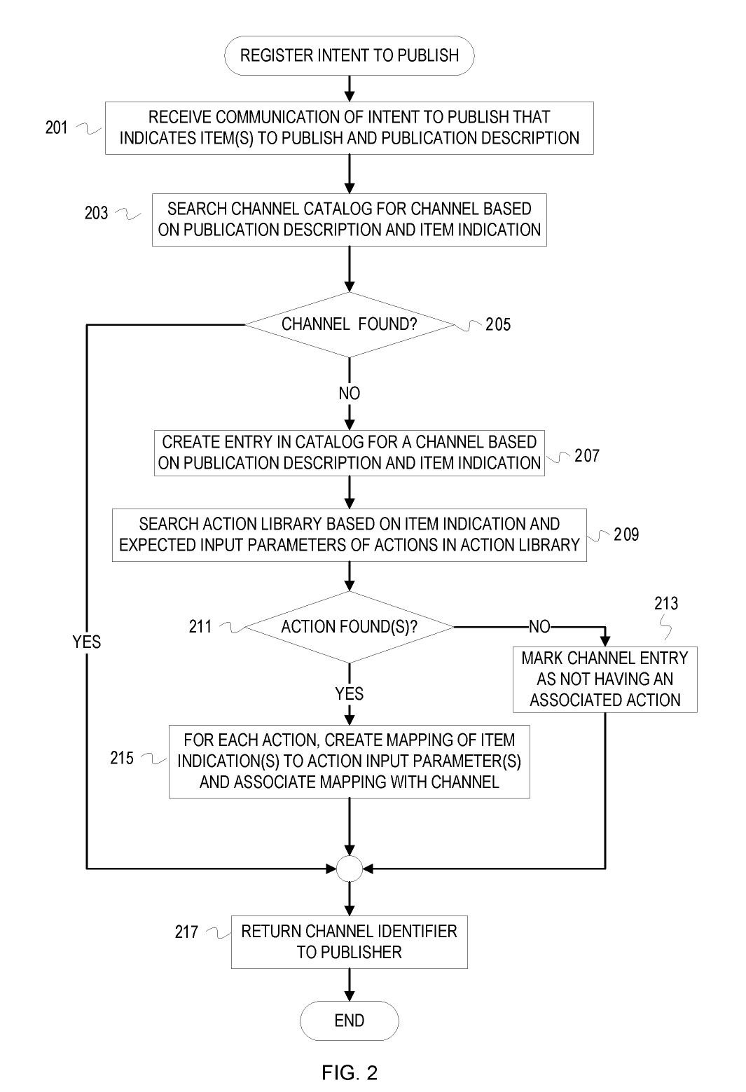

FIG. 2 is a flowchart of example operations for registering a publisher's intent to publish information. For consistency with FIG. 1, the FIG. 2 description refers to a broker as performing the operations. In addition to updating a channel catalog, registering an intent to publish involves creating mappings between action invocations and published items.

A broker receives a communication that indicates an intent to publish from a publisher node (201). The publisher node is a device that hosts program code for registering an intent to publish with the pub/sub system and publishing information to the pub/sub system, in particular a broker of the pub/sub system.

After receipt of the communication, the broker searches a channel catalog based on the communication (203). The communication comprises a description(s) of the item or items intended to be published (“publication description”) and indication of the item(s). For instance, the communication can indicate that the publication item will be a set of geographic coordinates (i.e., item indication). The publication description is a set of descriptors that provide context for the publication item. For instance, the publication description can be a narrative description, set of tags, etc., that describes the publication as location information of a vehicle and provides an identifier of the vehicle. The broker searches the channel catalog for an entry or entries that match (e.g., beyond a confidence threshold) the intended publication. For example, the broker searches the channel catalog with keywords from the publication description. In some implementations, the channel descriptions are updated with descriptors of an associated action.

If a channel is found, then the broker returns an identifier of the matching channel to the publisher (217). When the publisher publishes a publication item, the publisher can communicate the channel identifier for the broker to efficiently publish the publication item to the channel. If the channel is not found (205), then the broker updates the channel catalog. The broker creates an entry in the channel catalog for a channel based on the publication description and the item indication(s) in the intent to publish communication from the publisher (207). The broker creates the entry with a channel identifier, the item indication, and a description of the channel, which may be the publication description. Channel descriptions may be generalized or pre-defined to allow for multiple publishers to match to a channel and publish to the channel. The broker also searches an action library based on the item indication and input parameters specified for the action invocation in the action library (209). As previously mentioned, the action library is a library of action invocations. The library can take the form of a database, a set of files, a single file, etc. An entry in the action library comprises an action invocation definition. The action invocation definition includes a format for an invocation and expected input parameters for the action invocation. These can be obtained from multiple application programming interfaces (APIs). An action library entry also comprises a description of the action to be invoked. The broker searches the action library for sufficient matches between the publication description and the action description. For instance, the broker may determine a match between a publication description that describes publishing images for investigating crimes and an action description that describes an action that processes images to determine a location corresponding to the image. The match is also contingent upon conformity of the item indication to the input parameter of the action invocation. For instance, the expected input parameter for the action invocation may one of multiple specified image formats.

Depending upon the result of the search (211), the broker will either associate the found action invocation(s) to the created channel (215) or mark the channel as not having an associated action invocation (213). The broker can mark the created channel as not having an associated (213) and later use the marking to efficiently evaluate published items for derivation and/or evaluation subscriptions. The marking can be a flag or null value set in a field associated with the channel entry. If the broker associates an action invocation to a channel entry by reference (e.g., an index or pointer to an action library entry), then a null value can be used to represent the lack of an association between a channel and an action invocation. In the case of a matched action invocation, the broker creates a mapping of an item indication(s) to the input parameter(s) of each matched action invocation (215). The mapping indicates how to populate an action invocation with a published item(s) as an argument(s). Since an action invocation may have multiple input parameters, the mapping indicates which publication items of a channel map to which input parameters. In determining the mapping, the broker aligns data types of publication items with the expected data types of input parameters, as well as the descriptors for the input parameters. Thus, a channel may have multiple publication items of a same data type (e.g., altitude and coordinates as integers). The broker maps the publication items with the input parameters based on the input parameter descriptors, which would at least include keywords or tags that match the descriptors of the item indications.

After channel creation or finding a channel match, the broker returns a channel identifier to the publisher node that communicated the intent to publish (217). The broker returns a response as an acknowledgement of receipt of the intent to publish and to provide the publisher a channel identifier than can be used to quickly publish information to the identified channel.

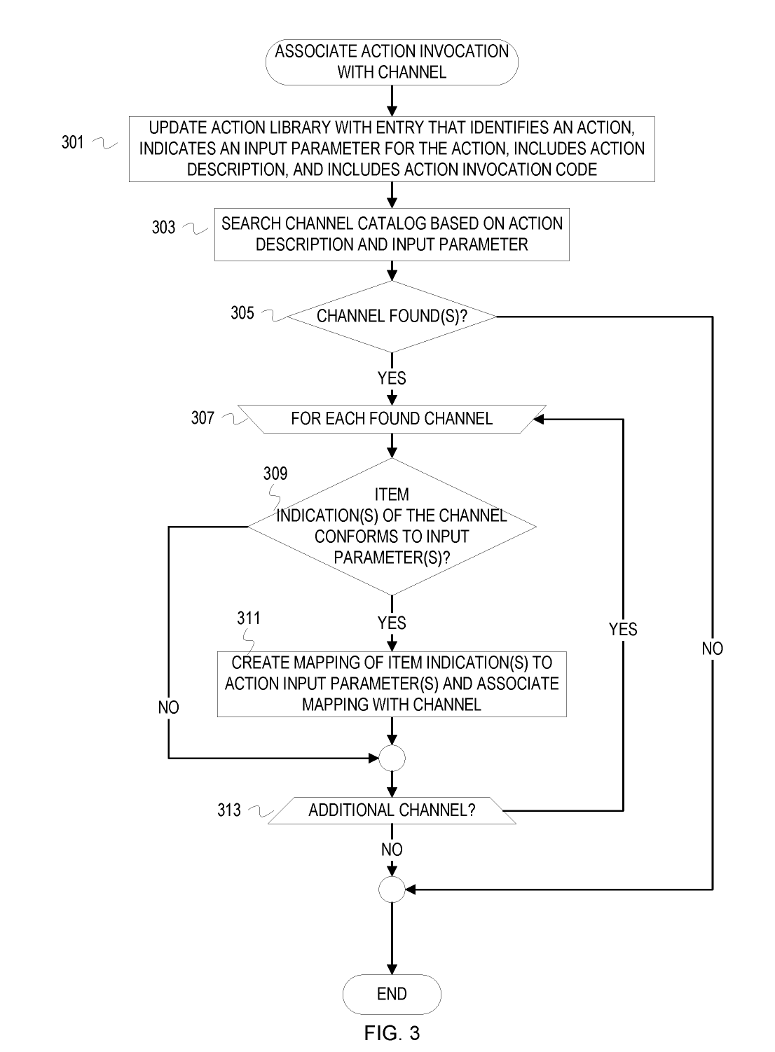

Since the disclosed pub/sub system incorporates invocation of derivation actions, a broker may also manage the action library and/or update a channel catalog based on an update to the action library as well as when a channel is created. FIG. 3 is a flowchart of example operations for associating an action invocation with one or more channels. Publishers and/or subscribers can request that a pub/sub system added or modify the derivation actions interfaced by the pub/sub system. The pub/sub system itself may expand, reduce, or modify the derivation action invocations that it executes. This creates flexibility in information provided from a pub/sub system even if the published items remain changed since different derived information can be produced from the same published item. The description refers to the broker as performing the example operations, but embodiments can manage the action library external to the broker(s) of a pub/sub system.

When a derivation action is requested to be added to the pub/sub system, the broker updates the action library with an entry for the derivation action (301). The action library entry identifies the derivation action (e.g., function name), indicates one or more input parameters for the action invocation, includes or references program code for invoking the derivation action (“action invocation”), and describes the derivation action. The description or definition of the derivation action is a searchable description of what the derivation action does and/or the derived information produced from the derivation action. The searchable description may be a narrative description, unstructured tags/token/keywords, or a structured collection of tags/tokens/keywords. The derivation action description can also describe the input parameters (e.g., data types, parameter names, etc.). The information about the input parameters can be within the action entry but a separate field of the entry than the action description.

The broker searches the channel catalog based on the action description and the description of the input parameter(s), if distinct (303), for one or more channel matches. Again, a “match” is not necessarily an exact match and can be satisfaction of a confidence threshold (e.g., 80% of descriptors or descriptions match). The broker searches the channel catalog for a channel entry with a channel description that matches the action description. If no match is found, then the broker exits the process (305).

If the broker finds one or more channel matches (305), the broker evaluates each channel based on the derivation action information (307). The broker determines whether the item indication(s) of a matching channel conforms to the input parameter(s) of the derivation action (309). For instance, the broker determines whether the data types of the item indications satisfy the expected data types of the input parameters. The broker determines whether an appropriate number of item indications exist for the matching channel based on the number of input parameters. If the item indication(s) does not conform to the input parameter(s) (309), then the broker selects the next matched channel for evaluation (313). If the item indication(s) conforms to the input parameter(s) (309), then the broker creates a mapping of the item indication(s) to the action input parameter(s) and associates the mapping with the channel (311). The broker creates a data structure or populates fields of the channel entry that indicates how to populate the derivation action invocation with published items. For example, the broker creates a mapping that indicates the published items should populate the derivation action invocation as arguments in the order of temperature, longitude, latitude, and altitude. If there is an additional matched channel (313), then the broker proceeds to evaluate the next matched channel.

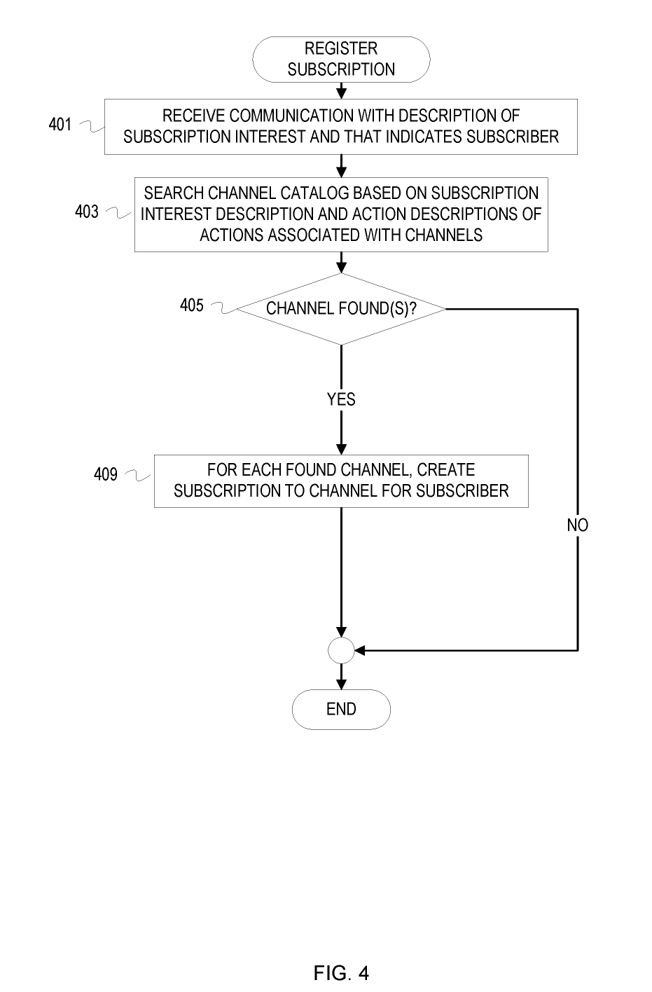

For subscribing to channels of a pub/sub system that incorporates derivation action invocations, the subscription process is expanded to account for matching subscription requests based on derivation action descriptions. FIG. 4 is a flowchart of example operations for registering a subscription with a pub/sub system that incorporates derivation actions. The broker receives a communication with a description of a subscription interest (401). The communication also indicates a subscriber node. For instance, the subscriber indication may be an application name, application name and device identifier (e.g., phone number), etc. The broker uses the subscriber indication to register the subscription. The description of subscription interest may be a topic selected from a menu of an application instance, a topic or set of keywords/terms pre-defined in an application instance, a selection from the channel catalog presented to the subscriber node, etc.

The broker searches the channel catalog based on the subscription interest description (403). The broker searches the channel catalog for matches based on both the channel descriptions and the derivation action descriptions. In some implementations, the pub/sub system incorporates a derivation action description into a channel description for a channel associated with the derivation action. For instance, a channel description based on a publication description may indicate images of for investigation and the derivation action description may indicate locations derived from images. A subscription interest description that indicates location of people based on images would match. If no match is found (405), then the broker exits the process. If the broker finds a match for the subscription (405), then the broker creates a subscription for the subscriber to each matching channel (409).

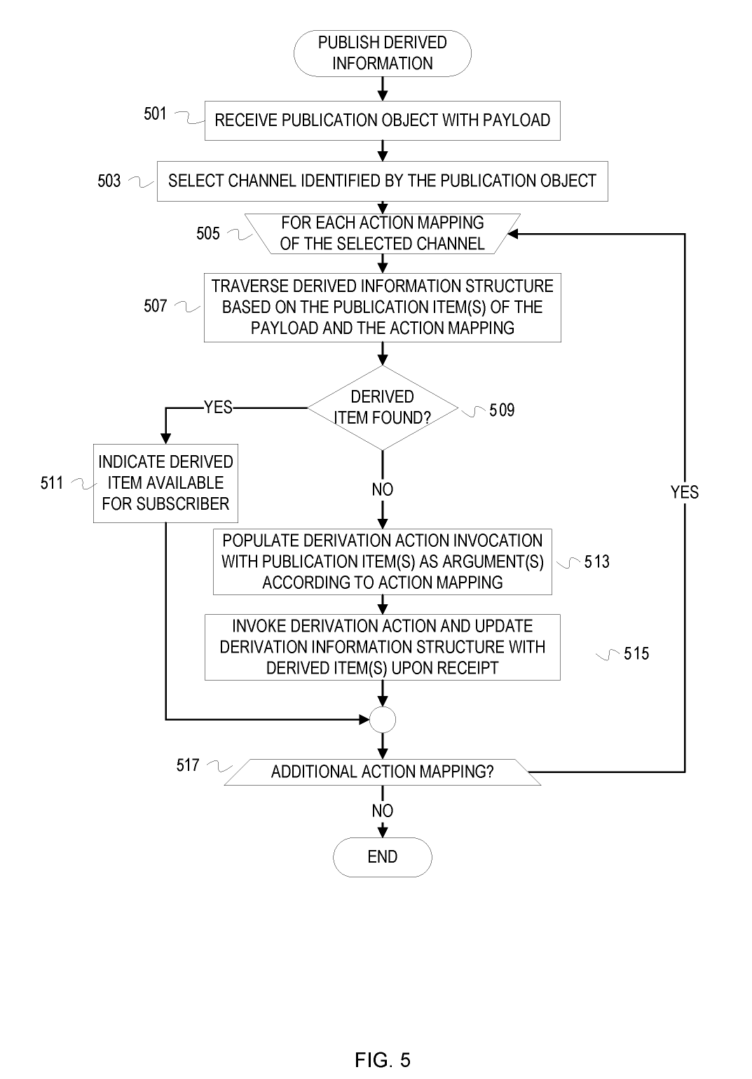

The incorporation of derivation action invocation into the pub/sub system is most apparent when an item is published from a publisher. Publication of an item from a publisher triggers a derivation action invocation to obtain derived information or leverages already cached derived information. FIG. 5 is a flowchart of example operations for publishing derived information. A broker receives a publication object with a payload (501). As previously discussed, a payload may contain one or more publication/published items. For example, a payload may include temperature and geographic coordinates. The geographic coordinates may be processed as a single published item or multiple published items (i.e., each of the longitude, the latitude, and the altitude is considered a different published item).

The broker selects from the channel catalog a channel identified in the publication object (503). The publication object can indicate a channel identifier, which can be a name, number, etc. The channel, or channel entry, has one or more derivation action invocations associated with it. Each associated derivation action invocation has a mapping of publication item(s) to input parameter(s).

The broker evaluates the publication payload against each of the mappings (505). Each mapping is associated with a derived information structure. The derived information structure is data structure that stores derived information obtained by the pub/sub system from invoking derivation actions. The derived information structure relates each unique published item to information derived from the published item from a derivation action. This can be a tree structure rooted to the channel or each derivation action mapping of the channel. The tree structure includes interior nodes to store the published items and leaf nodes to store derived information. The broker traverses the derivation information structure to find a published item (507). A published item resolves to a derived information in a leaf node if the derived information has already been obtained. Effectively, derived information is “cached” in the derivation information structure since subsequent publications of the same publication item retrieve the derived information from the derivation information structure instead of invoking the associated derivation action. If the broker resolves the publication item of the publication payload to derived information (509), then the broker indicates the derived information or derived item as available for a subscriber (511). The broker may notify a subscriber for retrieval by the subscriber (pull paradigm) or communicate the derived item to a subscriber (push paradigm). A broker may aggregate multiple derived items before fulfilling a subscription.

If the broker does not resolve the publication item to a derived item (509), then the broker invokes the mapped derivation action (513). The broker populates the derivation action invocation with the publication item(s) from the payload as an argument(s) according to the derivation action mapping. Once populated with the publication item(s) as the argument(s), the broker invokes the derivation action (515). When the derived item(s) is received, the broker will update the derivation information structure. If there is an additional derivation action mapping for the channel (517), then the broker proceeds to processing the next mapping.

Variations

The description refers to entries of a catalog or entries of a library. An “entry” depends upon implementation. For example, an entry may be a row in a database table, may be a document, a key-value pair, etc.

This disclosure describes communicating information derived from information published from a publisher. A pub/sub system can maintain a channel catalog that allows for subscription to the publication items as well as the derived items. A pub/sub system can maintain separate catalogs depending upon whether subscriptions are to published items or derived items.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations to create a channel entry in the channel catalog can include associating one or more derivation actions with the channel entry. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

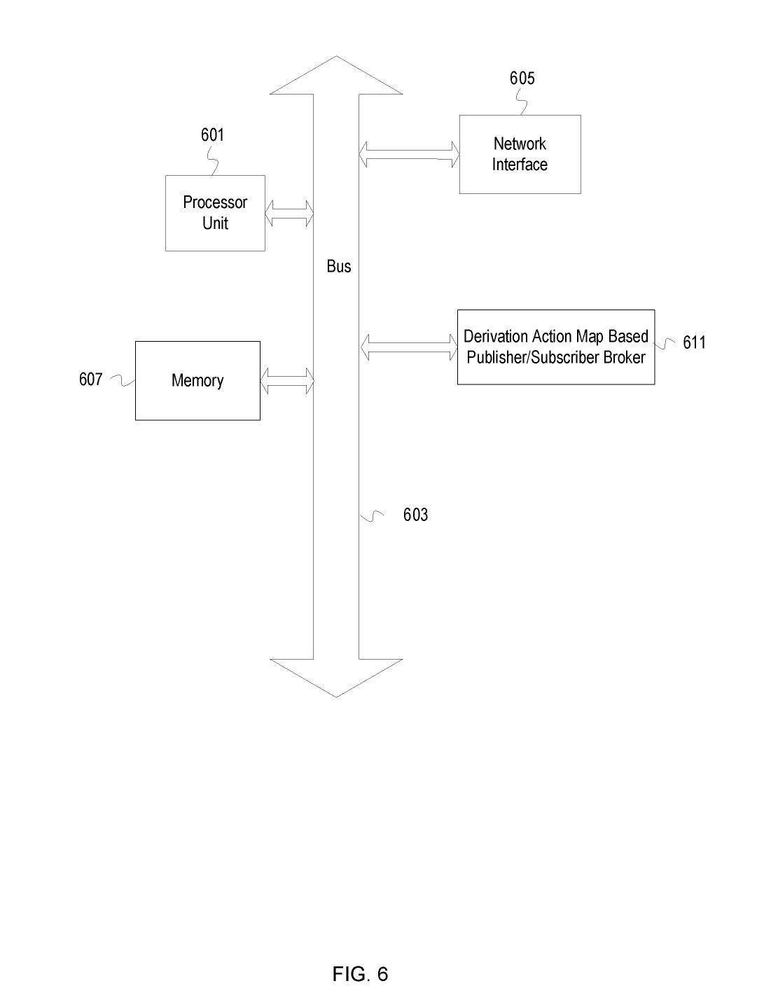

FIG. 6 depicts an example computer system with a derivation action map based publisher/subscriber broker. The computer system includes a processor unit 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes a derivation action map based publisher/subscriber broker 611. The broker 611 associates one or more derivation actions with a channel and invokes the associated derivation action(s) to obtain an item or items derived from a published item. For each channel, the broker 611 maintains at least one derivation information structure as a cache of derived information. Any one of the previously described functionalities may be partially (or entirely) implemented in hardware and/or on the processor unit 601. For example, the functionality may be implemented with an application specific integrated circuit, in logic implemented in the processor unit 601, in a co-processor on a peripheral device or card, etc. Further, realizations may include fewer or additional components not illustrated in FIG. 6 (e.g., video cards, audio cards, additional network interfaces, peripheral devices, etc.). The processor unit 601 and the network interface 605 are coupled to the bus 603. Although illustrated as being coupled to the bus 603, the memory 607 may be coupled to the processor unit 601.

While the aspects of the disclosure are described with reference to various implementations and exploitations, it will be understood that these aspects are illustrative and that the scope of the claims is not limited to them. In general, techniques for integrating requests for information derived from published items into a publish/subscribe system as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
based on receipt of an item published from a first publisher, identifying a channel for the published item;
determining whether information derived from the published item is cached for a publisher/subscriber intermediary for the channel;
based on a determination that derived information corresponding to the published item is not cached for the channel,
determining a derivation action based on the channel and the published item,
invoking the derivation action with the published item as an argument,
caching derivation information obtained from invoking the derivation action, wherein the caching comprises caching the derivation information in association with the channel and the published item, and
based on a determination that derived information for the published item is cached for the channel or after caching the derivation information obtained from invoking the derivation action, fulfilling a set of one or more subscriptions to the channel with the cached, derived information.

2. The method of claim 1, wherein determining whether information derived from the published item is cached at the publisher/subscriber intermediary for the channel comprises searching for the published item in a data structure for the channel that stores derived information per unique published item.

3. The method of claim 2, wherein the data structure comprises interior nodes for unique items published to the channel and leaf nodes for the information derived from the unique published items.

4. The method of claim 2, wherein caching the derivation information in association with the channel and the published item comprises updating the data structure with an interior node that indicates the published item and a leaf node associated with the interior node, wherein the leaf node indicates the information derived from the published item.

5. The method of claim 1 further comprising instantiating a derivation action invocation according to a mapping that maps one or more items of the channel to one or more input parameters of the derivation action invocation.

6. The method of claim 1, wherein invoking the derivation action with the published item as an argument comprises communicating a request to a web service that processes the published item to generate the derived information.

7. The method of claim 1 further comprising:
based on receipt of the item published from a second publisher, identifying the channel for the published item;
determining that the information derived from the published item is cached for the channel; and
fulfilling the set of one or more subscriptions to the channel with the cached, derived information.

8. One or more non-transitory machine-readable media comprising program code for incorporating derived web services information into a publisher/subscriber intermediary, the program code comprising instructions to:
based on receipt of an item published from a first publisher, identify a channel for the published item;
determine whether information derived from the published item is cached for the publisher/subscriber intermediary for the channel;
based on a determination that derived information corresponding to the published item is not cached for the channel,
determine a derivation action based on the channel and the published item,
invoke the derivation action with the published item as an argument,
cache derivation information obtained from invoking the derivation action, wherein the instructions to cache comprise instructions to cache the derivation information in association with the channel and the published item, and
based on a determination that derived information for the published item is cached for the channel or after caching the derivation information obtained from invoking the derivation action, fulfill a set of one or more subscriptions to the channel with the cached, derived information.

9. The non-transitory machine-readable media of claim 8, wherein the instructions to determine whether information derived from the published item is cached at the publisher/subscriber intermediary for the channel comprise instructions to search for the published item in a data structure for the channel that stores derived information per unique published item.

10. The non-transitory machine-readable media of claim 9, wherein the data structure comprises interior nodes for unique items published to the channel and leaf nodes for the information derived from the unique published items.

11. The non-transitory machine-readable media of claim 9, wherein the instructions to cache the derivation information in association with the channel and the published item comprise instructions to update the data structure with an interior node that indicates the published item and a leaf node associated with the interior node, wherein the leaf node indicates the information derived from the published item.

12. The non-transitory machine-readable media of claim 8, wherein the program code further comprises instructions to instantiate a derivation action invocation according to a mapping that maps one or more items of the channel to one or more input parameters of the derivation action invocation.

13. The non-transitory machine-readable media of claim 8, wherein the instructions to invoke the derivation action with the published item as an argument comprise instructions to communicate a request to a web service that processes the published item to generate the derived information.

14. An apparatus comprising:
a processor;
a network interface; and
a machine-readable medium having instructions executable by the processor to cause the apparatus to,
based on receipt of an item via the network interface published from a first publisher, identify a channel for the published item;
determine whether information derived from the published item is cached for the channel of a publisher/subscriber intermediary hosted on the apparatus;
based on a determination that derived information corresponding to the published item is not cached for the channel,
determine a derivation action based on the channel and the published item,
invoke the derivation action with the published item as an argument,
cache derivation information obtained from invoking the derivation action, wherein the instructions to cache comprise instructions to cache the derivation information in association with the channel and the published item, and
based on a determination that derived information for the published item is cached for the channel or after caching the derivation information obtained from invoking the derivation action, fulfill a set of one or more subscriptions to the channel with the cached, derived information.

15. The apparatus of claim 14, wherein the instructions to determine whether information derived from the published item is cached at the publisher/subscriber intermediary for the channel comprise instructions executable by the processor to cause the apparatus to search for the published item in a data structure for the channel that stores derived information per unique published item.

16. The apparatus of claim 15, wherein the data structure comprises interior nodes for unique items published to the channel and leaf nodes for the information derived from the unique published items.

17. The apparatus of claim 15, wherein the instructions to cache the derivation information in association with the channel and the published item comprise instructions executable by the processor to cause the apparatus to update the data structure with an interior node that indicates the published item and a leaf node associated with the interior node, wherein the leaf node indicates the information derived from the published item.

18. The apparatus of claim 14, wherein the program code further comprises instructions executable by the processor to cause the apparatus to instantiate a derivation action invocation according to a mapping that maps one or more items of the channel to one or more input parameters of the derivation action invocation.

19. The apparatus of claim 14, wherein the instructions to invoke the derivation action with the published item as an argument comprise instructions executable by the processor to cause the apparatus to communicate a request to a web service that processes the published item to generate the derived information.

20. The apparatus of claim 14, wherein the instructions to invoke the derivation action with the published item as an argument comprise instructions executable by the processor to cause the apparatus to communicate a request to a web service that processes the published item to generate the derived information.
